(19) United States
(12) Patent Application Publication
(10) Pub. No.: US 2007/0294230 A1
(43) Pub. Date: Dec. 20, 2007

(54) Dynamic content analysis of collected online discussions

(76) Inventors: Joshua Sinel, Bedford Corners, NY (US); Larisa Kalman, Brooklyn, NY (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 11/806,524

(22) Filed: May 31, 2007

Related U.S. Application Data
(60) Provisional application No. 60/809,388, filed on May 31, 2006.

(51) Int. Cl. G06F 17/30; G06F 7/00

(52) U.S. Cl. 707/3; 707/102; 707/100; 707/1

(57) ABSTRACT

The present invention is an enterprise solution that comprises methods for collecting, storing, categorizing, and analyzing online peer-to-peer discussions in order to illuminate key consumer insights—clarify public opinion, quantify trends and findings, and develop the components for completed consumer research studies. The inventive system analyzes collected data based on predetermined attributes that are contained within the multi-dimensional structure of each “data unit,” leading to the dynamic generation of content analysis.

### CROSS-REFERENCE TO RELATED APPLICATION

This application claims the benefit of the filing date of U.S. Provisional Application Ser. No. 60/809,388, filed on May 31, 2006, which is hereby incorporated by reference.

### BACKGROUND OF THE INVENTION

1. Field of the Invention

The present invention relates to data collection, organization, and analysis of online peer-to-peer discussions; more specifically, the dynamic analysis of the content and other known attributes of collected and stored messages or data units.

2. Related Art

Online communities—message board forums, chats, blogs, and email lists—give the Internet-enabled public the opportunity to share their opinions and beliefs across a vast array of topics. The constantly growing number of such online outlets has formed an ongoing and reliable source of consumer information.

Because this consumer data exists in massive amounts, across a wide landscape of internet sites, and in digital formats, an application has been developed to greatly enhance human skills at parsing the data for context and meaning.

### SUMMARY OF THE INVENTION

The present invention provides services that allow the accurate and efficient collection and analysis of online discussions in order to quantify, qualify, and determine the essence and value of public opinion, and to identify and measure consumer belief and opinion trends across various markets.

### BRIEF DESCRIPTION OF THE FIGURES/DRAWINGS

FIG. 1 is a data architecture diagram according to one embodiment of the present invention.

FIG. 1.1: Forum observation and configuration—configuration file in XML format.

FIG. 1.2: The Automated Database Creation—creates new database for application services.

FIG. 1.2.1: The Management Central Service provides automatic database creation. The service is capable of creating complex databases in less than a minute.

FIG. 1.2.2: Entity Schema—master schema defined in an XML document and describes database entity.

FIG. 1.3: Data Storage—data can be comprised of multiple stored databases.

FIG. 1.3.1: Services—internal database to manage the jobs of several key services: Management Central Service (1.2.1) and Data Transformation Services (1.5).

FIG. 1.3.2: Application—database that coordinates the analysis and categorization of the databases and data units.

FIG. 1.3.3: Analysis—database collection. Each database collects community data by subject matter and is automatically created (1.2) by processing existing schema (1.2.2).

FIG. 1.4: Data Collection Service—FIG. 1.4.1: Dialogue Collection Service—data crawler retrieves information from pre-determined online, public data sources.

FIG. 1.5: Data Transformation—set of services that enable the transformation of unstructured online discussion messages into structured and dimensional data units for further categorization and analysis.

FIG. 1.5.1: Word Parsing Service—splits text messages into words to populate the system's words catalog.

FIG. 1.5.2: Phrase Parsing Service—develops and populates the system's phrases catalog to increase search capabilities during analysis.

FIG. 1.6: Data Analysis Service—graphic user interface allows the end user to interact with collected data in a dynamic and multidimensional environment and provides efficient and effective means for accurate and sophisticated analysis.

FIG. 1.6.1: Dialogue Manager—components comprising a single message or data unit: message body or dialogue, message author, date/time stamp, and message source.

FIG. 1.6.2: Authors—participants responsible for publishing text messages related to particular dialogues (see FIG. 1.6.1), words (see FIG. 1.6.3), phrases (see FIG. 1.6.4), and data sources.

FIG. 1.6.3: Words—the collection of significant words related to particular dialogues (1.6.1), authors (1.6.2), and data sources.

FIG. 1.6.4: Phrases—the collection of significant phrases related to particular dialogues (1.6.1), authors (1.6.2), and data sources.

FIG. 1.6.5: Time Graph—graphic control allows end-users to view particular communities' activity over time; monthly, daily, and hourly.

FIG. 1.6.6: Query Analyzer—collection and display of queries previously processed by analysts/end-users.

FIG. 1.7: Study Composition—structured environment that stores and represents quantitative and qualitative analysis, key verbatim commentary, and written analysts' insight.

FIG. 1.7.1: Study Working Environment—hierarchical tree structure component for preserving the analyzed data across intuitive working sections.

FIG. 1.7.2: Study Outline—hierarchical tree structure component for accumulating final study data that has been imported from the Study Working Environment (1.7.1).

FIG. 1.7.3: Study—MS Word document, automatically created by parsing the final data in the Study Outline (1.7.2) into a preformatted template.

FIG. 2: Analysis Services—Graphic User Interface—View 1

FIG. 2.1: Dialogue Manager—component that displays a single discussion message (data unit) along with its associated set of attributes: source, subject, author, and date/time posted.

FIG. 2.2: Global Search Area—area to enter search terms.

FIG. 2.3: Time Line Graph displays number of discussions over time—monthly, daily, hourly.

FIG. 2.4: Study Working Environment—tree structured component, enabling auto-quantification of pre-categorized data and the storage of other various types of data objects necessary for the analyst/end-user to carry with them through the analysis and study development process.

FIG. 2.5: Words Catalog—collection of significant words and a tally of each word's count.

FIG. 2.6: Communities—tree structured component representing the individual sources that may make up a single study's database.

FIG. 3: Analysis Services—Graphic User Interface—View 2

FIG. 3.1: Insights—a text entry window where analyst/end-users can write a study's narrative and associate it with other elements within the Study Working Environment.

FIG. 3.2: Author—represents the total participants by user name and the number of messages each has published within the total data set.

FIG. 3.3: Phrases—catalogue and representation of significant phrases and the number of instances each phrase occurs within the total data set.

FIG. 3.4: Query Analyzer—collection and display of queries previously processed by analysts/end-users.

FIG. 3.5: Study Outline—tree structured component representing the final study ready for publication to pre-formatted MS Word template.

FIG. 4: Diagram—displays the relationship between a single dialogue and its position in the Words and Phrases catalogs.

FIG. 5: Graphic User Interface—Dynamic data entry with Words Catalog (view 1).

FIG. 6: Graphic User Interface—Dynamic data entry with Words Catalog (view 2).

FIG. 7: Graphic User Interface—Dynamic analysis (view 1).

FIG. 8: Graphic User Interface—Dynamic analysis (view 2).

FIG. 9: Graphic User Interface—Dynamic analysis over time (Day mode).

FIG. 10: Graphic User Interface—Dynamic analysis over time (Hour mode).

FIG. 11: Graphic User Interface—Multidimensional analysis by Author.

FIG. 12: Graphic User Interface—Multidimensional analysis by Community topic.

FIG. 13: Graphic User Interface—Multidimensional analysis by Query.

FIG. 14: Graphic User Interface—Multidimensional analysis by Query (Drill down and expanding concepts).

FIG. 15: Graphic User Interface—Categorization.

FIG. 16: Graphic User Interface—Automation activation: Applying analysis structure to database (view 1).

FIG. 17: Graphic User Interface—Automation activation: Applying analysis structure to database (view 2).

FIG. 18: Application Architecture Diagram of a Preferred Embodiment of the Invention FIG. 19: Graphic User Interface—Analysis Services.

FIG. 20: Graphic User Interface—Study Composition Services.

FIG. 21: Graphic Display of Study Results.

FIG. 22: Graph of Brand Mentions Over Time.

### DETAILED DESCRIPTION OF THE INVENTION

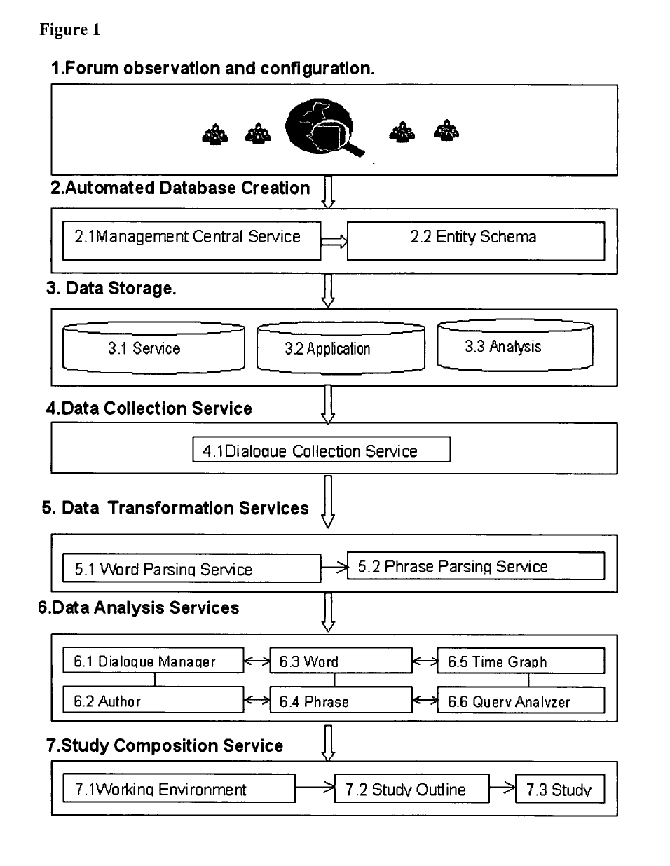

For purposes of illustration, the present invention is described in reference to a preferred system architecture as depicted in FIG. 1.

This enterprise application has been designed using a services-centric paradigm and an n-tiered architecture to automate the content analysis of collected online peer-to-peer discussions, quantify and qualify text messages, and produce accurate studies with high analytical requirements.

The forums' observation and configuration services (e.g., discussion configuration services) (FIG. 1.1) is a modified web crawler. It retrieves information from pre-determined peer-to-peer communications platforms. Each discussion platform may contain one or more boards, each board may contain one or more topics, and each topic may contain one or more messages or data units. The structure of each source is described in hierarchical order in an XML configuration file, which, when processed extracts the data into the application's analysis database (FIG. 1.3.3) for further analysis.

Automated Database Creation (FIG. 1.2) is executed by the Management Central Service (FIG. 1.2.1). The Analysis database (FIG. 1.3.3) represents a collection of databases. The Analysis database (FIG. 1.3.3) schema (FIG. 1.2.2) is defined in an XML document and includes information on what properties are associated with each entity, and how the entities are related within and across the databases.

Data Storage (FIG. 1.3) is spread across several databases. The Services (FIG. 1.3.1) database manages the functions of the following services: Management Central Service (FIG. 1.2.1) and Data Transformation Services (FIG. 1.5). Data Transformation Services (FIG. 1.5) deliver clean, searchable, comprehensible data from the unstructured data as it exists at the source. It is itself comprised of two services: Word Parsing Service (FIG. 1.5.1) and Phrase Parsing Service (FIG. 1.5.2). The Word Parsing Service (FIG. 1.5.1) initiates with the Dialogue Collection Service (FIG. 1.4.1) and parses individual words from the collected messages. The Service provides spell check analysis, as well as word grouping and aggregation. The Phrase Parsing Service (FIG. 1.5.2) follows the completion of the Word Parsing Service (FIG. 1.5.1) and uses the processed word-based data to reconstruct frequently repeated phrases.

The Application (FIG. 1.3.2) database coordinates the entire Analysis (FIG. 1.3.3) database collection related to a particular study or series of studies.

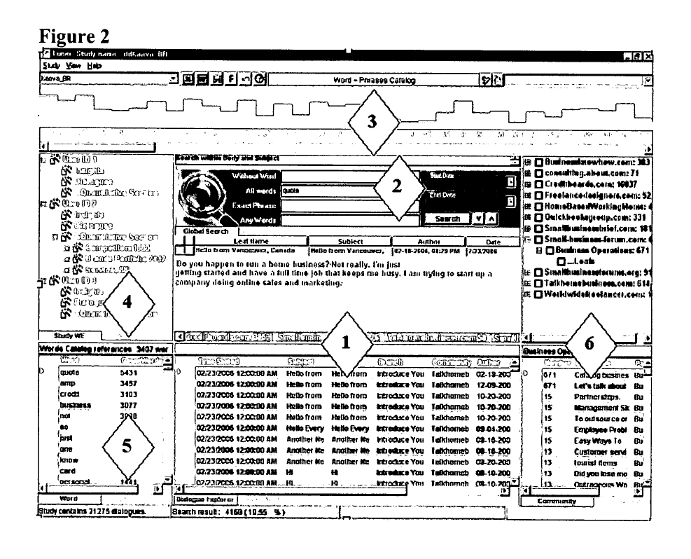

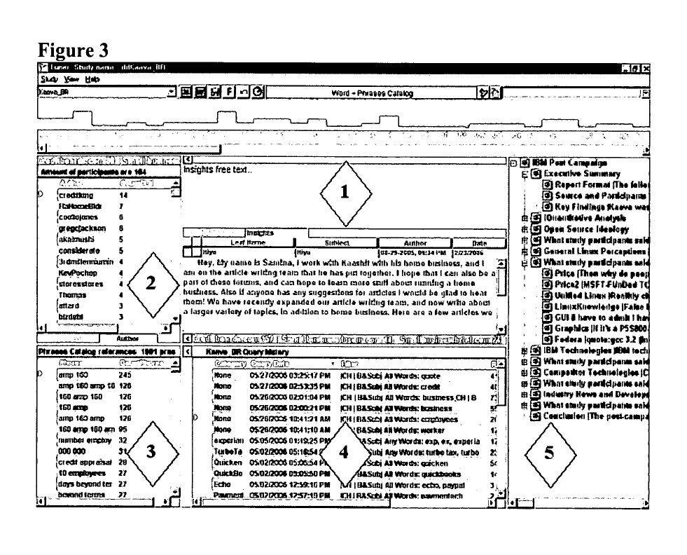

The Data Analysis Service (FIG. 1.6) is a graphic user interface (see, e.g., FIG. 2 and FIG. 3), comprised of a set of related components and functions, and represents the front-end of the dynamic search engine, capable of very quickly performing complex text-retrieval and relational data interactions and renderings. In a preferred embodiment, the relational components are: dialogue, word, phrase, author, community, time graph, and query.

The application's compact design allows the creation of complex queries that then present views of the various resulting data sets at the same time in dynamic or in static mode, with the ability to expand, narrow, or eliminate specific data result sets.

Queries can be created by entering search terms into text boxes within the Global Search Area (FIG. 2.2) or by double clicking on any of the presented data dimensions: word (FIG. 2.5), phrase (FIG. 3.3), author (FIG. 3.2), topic, time (FIG. 2.3), and query. Each query is then preserved in the Query Analyzer (FIG. 3.4), while working data analysis and end-user input is stored in the Study Working Environment (FIG. 2.4). Final analysis and narrative data can then be exported to the Study Outline (FIG. 3.5) where it is exported to a preformatted MS Word Document.

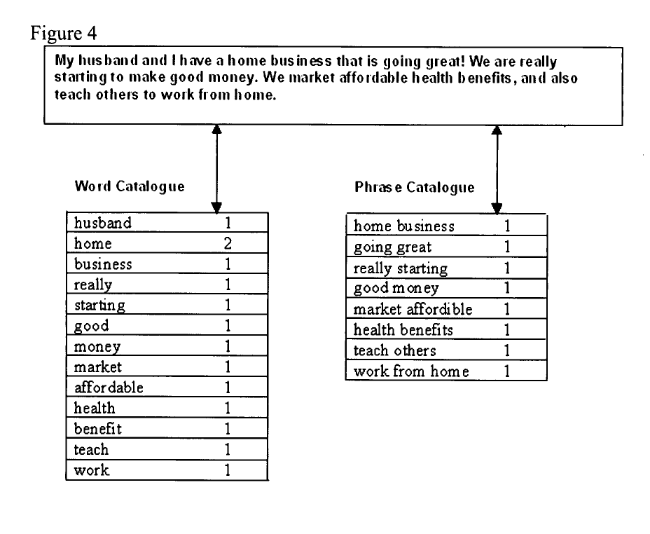

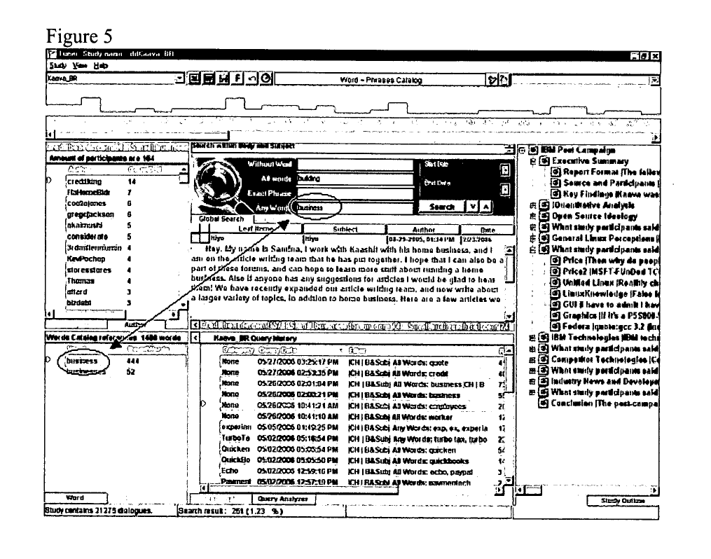

The dynamic search process relies on the build of the Words and Phrases catalogs during the data collection and transformation stages. Dialogues are essentially text messages, comprised of various words and phrases. Each message is processed to extract significant words and populate the collection within the Words catalog. Each word in that collection is unique and is associated with affixed number of mentions across the entire data set, across individual sets of authors, during any given time, and specific to each source. For example, the word ‘Husband’ in FIG. 4 is mentioned one time and the word “home” is mentioned two times. The fixed number of dialogues associated with various dimensions of the whole data set allows the application to compute the number of times each particular word is mentioned. The Phrases catalog is then comprised of words in the Words catalog in repeat mode (FIG. 4) where each dialogue, as well as the words and phrases that make up that dialogue, are uniquely identified in the database. Some words commonly used in consumer dialogues are excluded from the creation of the catalog.

In the current example those words are: “my,” “and,” “I” “a,” “that,” “is,” “are,” “to,” “make,” and “from.”

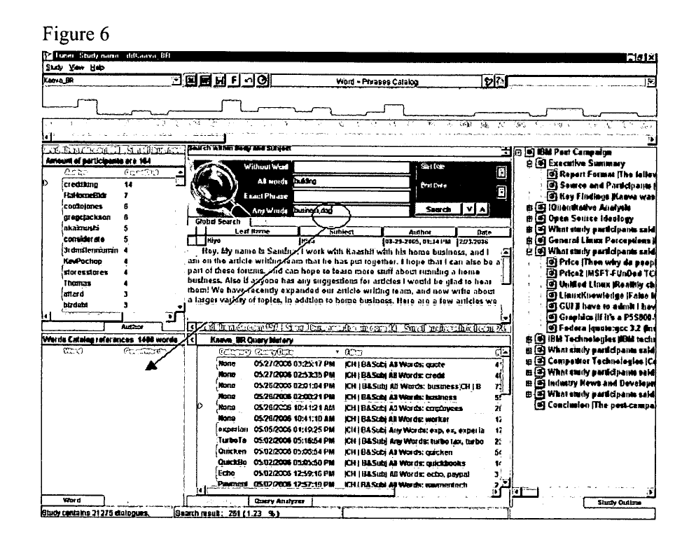

The Words and Phrases Catalogs and their displays are linked directly to the data entry fields within the Global Search Area. As the search word or phrase is entered into the text box the Word or Phrase catalog is dynamically adjusted for matches to the entered text. It is looking for significant word or phrase matches character by character until the complete term or phrase is displayed in the first position with an exact match and its quantitative value within the selected dimensions of the entire data set. For example, in FIG. 5 the word “business” exists within the catalogue and can be a relevant part of any search criteria. The number ‘444’ next to it represents the number of mentions of that word, “business.” If the word “dog,” for example, is entered into the input fields, the Word Catalog will render and display as empty (FIG. 6). This then dynamically represents that there are no words in the data set beginning from the root “dog,” and it is not a relevant string within a project's search criteria.

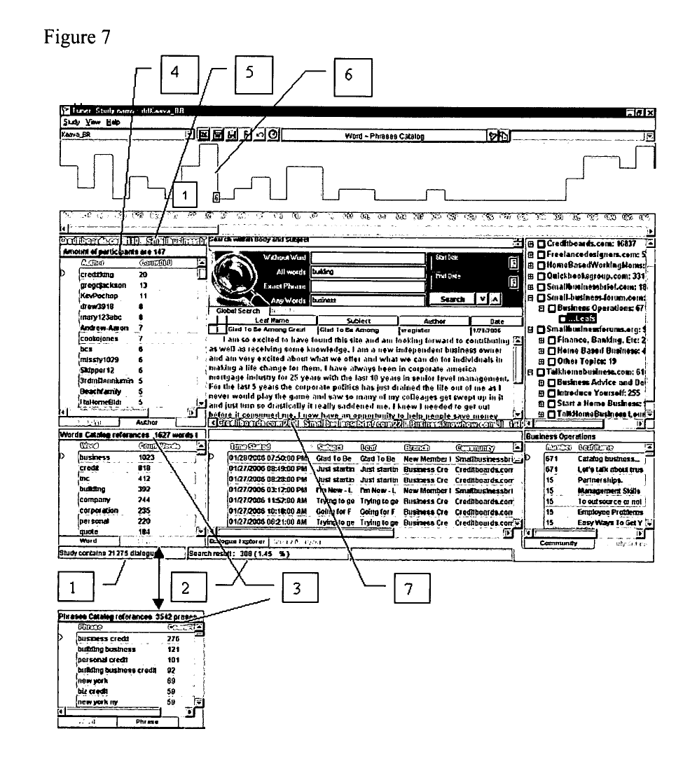

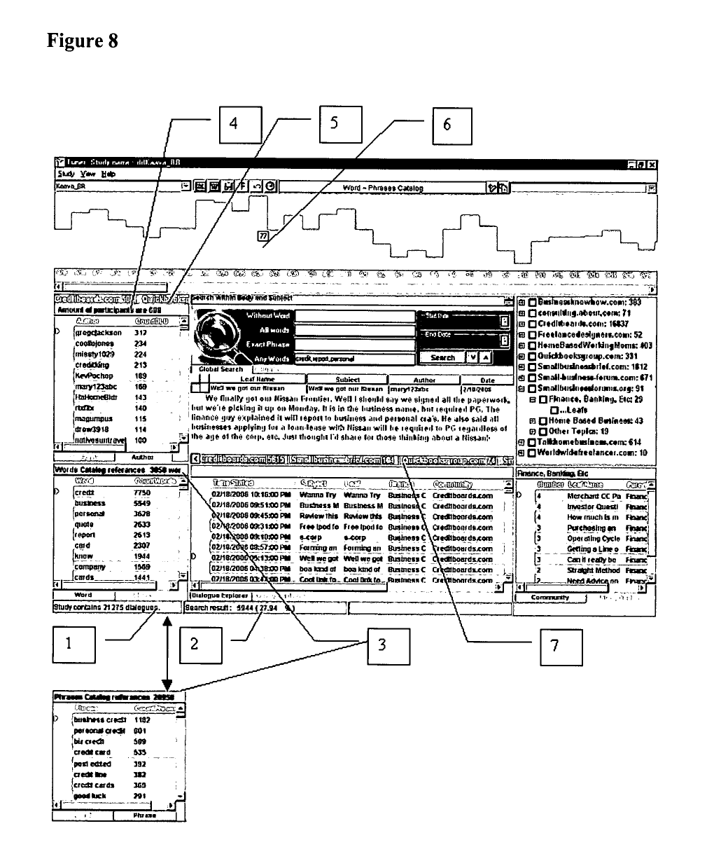

Each executed search dynamically updates every displayed component of the data set. Data is automatically reloaded and only that data associated with the search criteria is displayed. FIG. 7 demonstrates search execution with the search terms “building” and “business.” FIG. 8 demonstrates search execution with the search terms “credit,” “report,” and “personal.” FIG. 7.1 and FIG. 8.1 display the number of dialogues (data units) within the entire database. For any given study this is a constant number. Search results seen in FIG. 7.2 and FIG. 8.2 represent the amount of dialogues associated with each query result.

Each dialogue is comprised of words and phrases and every search dynamically displays only those related words and phrases. The search result set of 308 dialogues in FIG. 7.2 are comprised of 1627 words and 3542 phrases (FIG. 7.3). The search result set of 5944 dialogues in FIG. 8.2 are comprised of 3858 words and 20958 phrases (FIG. 7.3).

The numbers of times words and phrases are mentioned are also dynamically updated. For example, the word “business” is mentioned 1023 times in FIG. 7 and 5549 times in FIG. 8. The phrase “business credit” is mentioned 286 times in FIG. 7 and 1182 in FIG. 8.

Every dialogue has an author that is directly associated with that unique dialogue. After a search is executed the number of authors is also dynamically updated. For example, FIG. 8.4 contains 698 authors and FIG. 7.4 contains 147 authors. The number of dialogues associated with particular authors are counted and refreshed in the application's dynamic mode. For example, the author ‘creditking’ has 20 dialogues in FIG. 7.4 and 213 dialogues in FIG. 8.4.

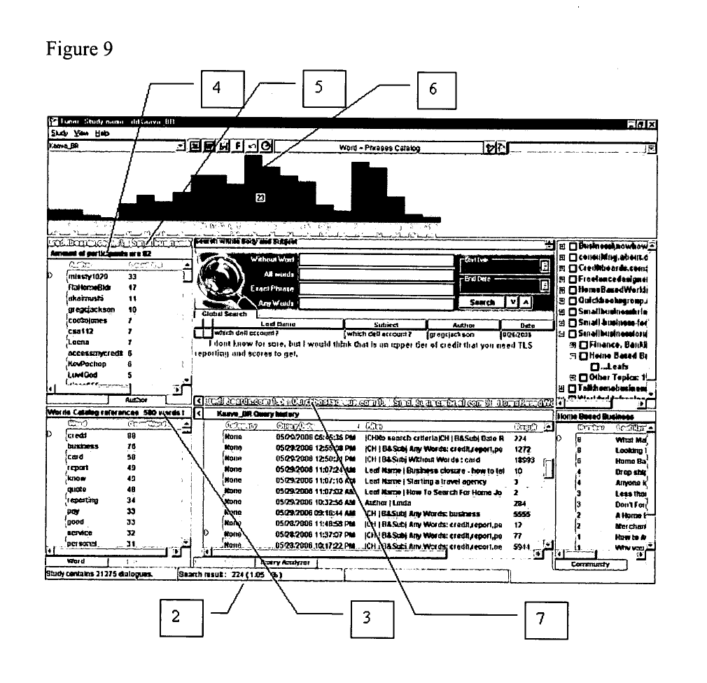

FIG. 8.5, FIG. 7.5, and FIG. 9.5 display the number of authors per source community, changing dynamically per search. The system can also identify authors who have actively published dialogues in more than one community within the total source set. FIG. 7.7, FIG. 8.7, and FIG. 9.7 display the number of dialogues per community, changing dynamically per search.

The time line graph control (FIG. 7.6 and FIG. 8.6) shows the amount of discussions over a span of time related to every executed query. For example, in FIG. 7.6, the amount of dialogues on 8/26 is 1 and the amount of dialogues in FIG. 8.6 on 8/26 is 77. Graphic depiction over time allows analysts/end-users to quickly identify “hot topics” by looking at activity spikes and relating them back to various market events.

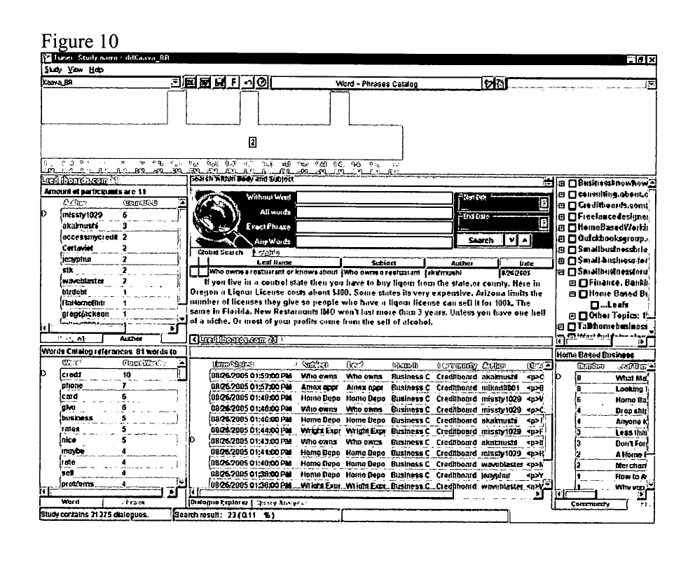

In a preferred embodiment, there are three modes of time line analysis: monthly, daily, and hourly, with the application defaulting to a monthly view. By selecting one or more days within the time line control a query will be executed, utilizing those days as search criteria. For example, if the date 8/26 is selected as a search criterion (FIG. 9) the search result is displayed on FIG. 9.2 with the system in Day mode. The Words catalog then indicates that 580 unique words have been used on 8/26 (FIG. 9.3), that 82 authors had been active (FIG. 9.4), and that 224 discussions took place (FIG. 9.2), all comprised of 580 unique words. In Day mode the spike on the time line graph control (FIG. 9.6) indicates the most active hour, and by selecting “8:00 PM” the system will execute it as a search criterion, moving the system to Hour mode (FIG. 10).

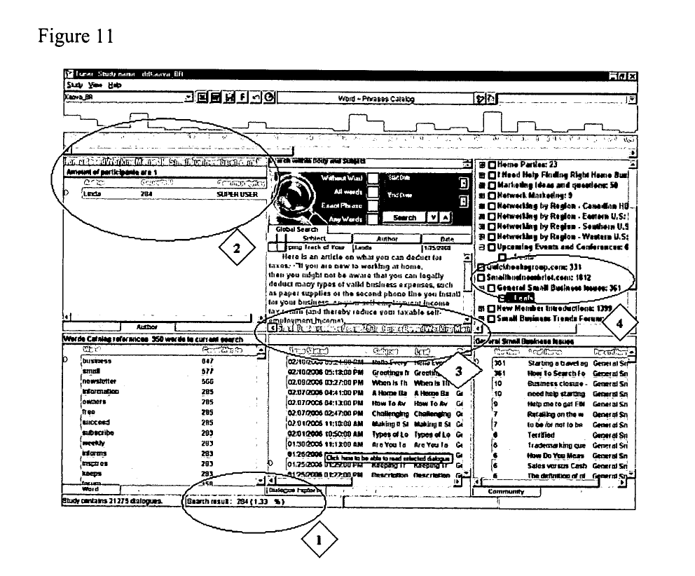

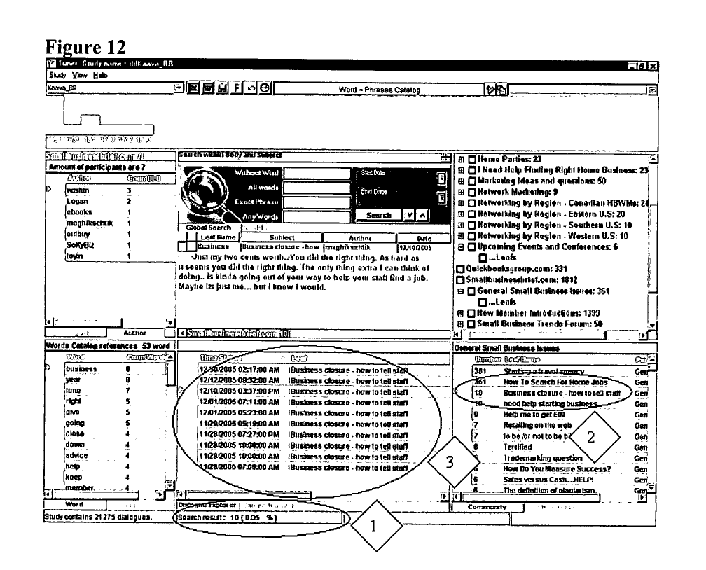

The present invention provides multidimensional analysis services that allow analysts/end-users to view data from within different frameworks (search criteria and other parameters) and provide multidimensional analysis of the structured data. Search dimensions such as; words, phrases, authors, topics, and time (month/day/hour), and query histories can be executed within one dimension at a time or combined with others in any order. For example, by double clicking on a particular author, “Linda,” only dialogue published across the data set by that author will be displayed. Linda published 284 dialogues (FIG. 11.2), which matches the previous search result 284 in FIG. 11.1. “Linda” participated in two forums and created 283 dialogues in the “Smallbusinessbrief” forum and 1 dialogue in the “HomeBasedWorkingMoms” forum (FIG. 11.3). The “Smallbusinessbrief” community contains 1812 total dialogues (FIG. 11.4) wherein 283 dialogues have been published by “Linda”

The data sources play a significant roll in the overall data analysis, wherein one or more communities can be selected for viewing or searching simultaneously. Each hierarchical element that represents a unique source can be dynamically utilized as search criteria. For example, where one specific topic is selected, “Business closure—how to tell staff . . . ” the topic contains 10 dialogues (FIG. 12.1) and the search result returns 10 dialogues (FIG. 12.2). FIG. 12.3 displays 10 rows of related dialogues.

The query is one of the more powerful elements of the multidimensional analysis services, where a query is auto generated following the selection of any one, or combination of, search criteria. Query results and the historical query structure are preserved in the Query Analyzer. Queries can be run and re-run an unlimited number of times and can be combined with any other query or dimension of the data. In a preferred embodiment, the Query Analyzer entities are: category, query date, filter, and result. The query date is a unique query identifier and represents the actual time of query execution, the filter is comprised of all combined search criteria, and the result is the amount of dialogues affected by query or search result. For example, FIG. 7, FIG. 8, FIG. 9, FIG. 10, and FIG. 11 demonstrate query composition and execution.

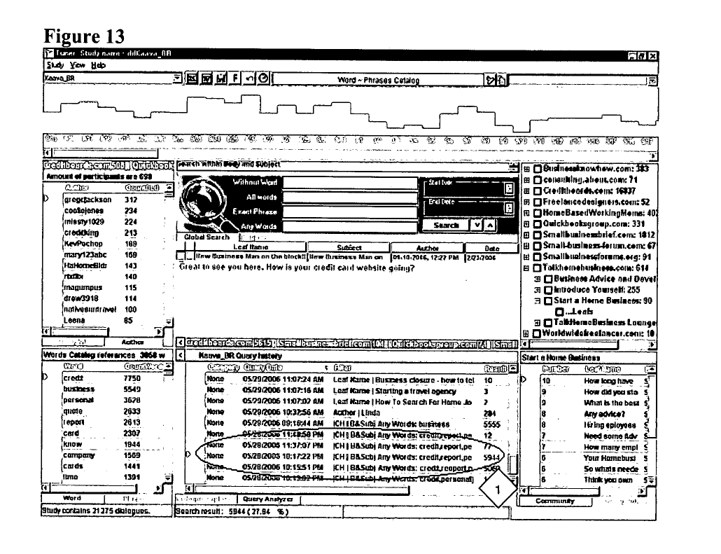

Several dimensions can be combined in any order for an unlimited number of queries until such combinations return meaningful results. For example, FIG. 13 demonstrates query execution from the Query Analyzer where the highlighted row represents a stored query from FIG. 8.

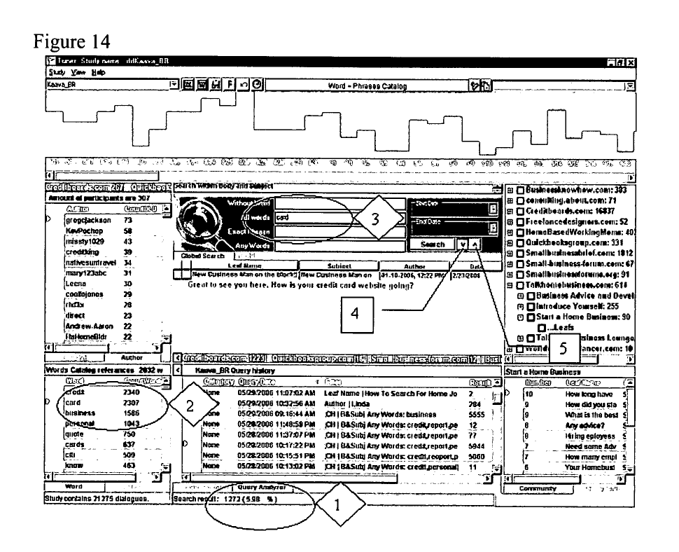

After a query has been executed it can still be combined with any other current query. For example, by clicking on the word “card” in FIG. 14.2 or 14.3, additional search criteria will be added to the existing query. There are two navigation buttons (FIGS. 14.4 and 14.5) that can combine current and historical queries with an ‘and’ operator or an “or” operator to both expand and to narrow the original result—see FIG. 14.1 compared to FIG. 13.1.

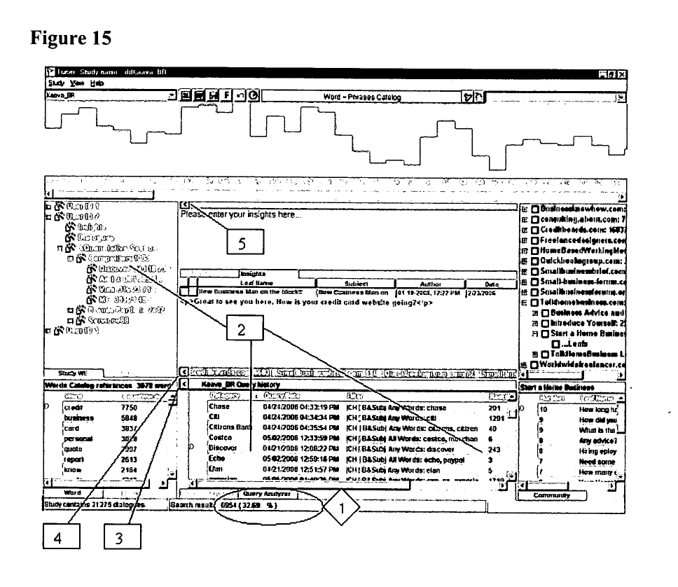

The present invention also provides for Categorization, which represents the process of assigning query results to predetermined project, or segment-based categories. Categories are created in the “% Quantitative Section” of the Study Working environment. A query result (FIG. 15.2) is assigned to a category by pressing button 15.3, which replaces the default value ‘None’ in the Category field in the Query Analyzer with an assigned category name. For example, by assigning a query result to the category “Discover” (FIG. 15.2), “None” is replaced by “Discover” and the query result ‘243’ appears in the Study Working Environment next to the pre-entered “Discover” category. When quantifying result sets, for instance, when all assignments to all categories on a competitor section are complete, the section is quantified and automatically computes % and total value of related discussions. Using graphic user interface buttons 15.4 and 15.5, respectively, verbatim consumer commentary and analyst/end-user generated insights can be assigned to corresponding quantified entities. FIG. 15.1 depicts a total search result.

Every entry in the Study Working Environment is managed through User ID control. In the current example User ID 2 is a valid user. When the Study Working Environment is finalized, the data will be exported to the Study Outline and the Final Study document will be generated.

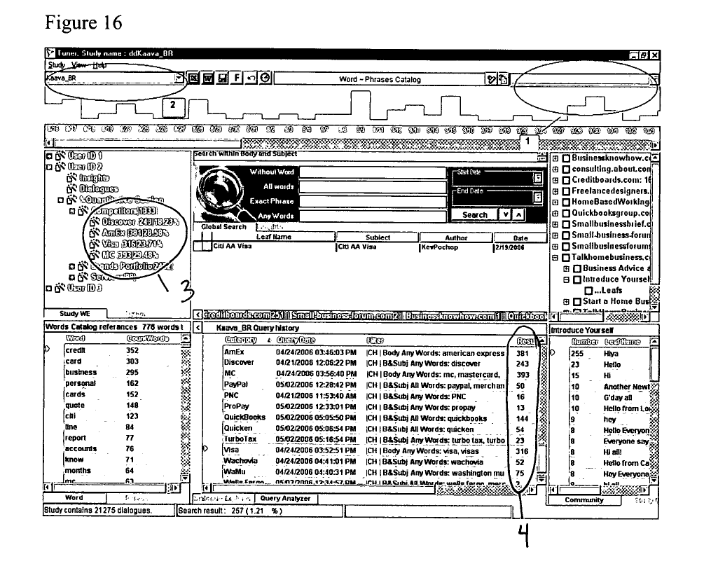

The present invention also provides Automated Analysis Services, which rely on applying existing structures to the analysis databases to quantify and qualify data without any user interaction. The key components of the Analysis Automation Services are: Query Analyzer (FIG. 3.4), Study Working Environment (FIG. 2.4), and Study Outline (FIG. 3.5). For example, FIG. 16.2 contains current database name, but FIG. 16.1 does not contain any data. This study has been created without involving automated analysis services.

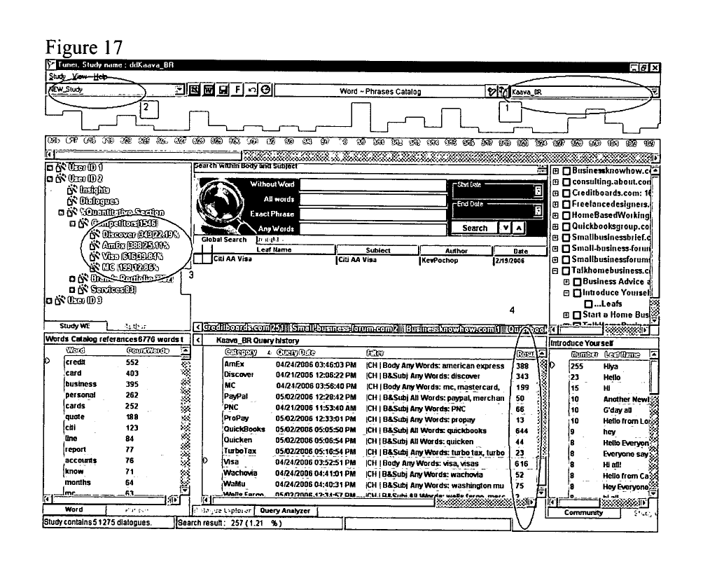

FIG. 16 demonstrates the Automated Analysis Services, with FIG. 16.1 containing a list of analysis databases ready to apply their structures to the current study's data set (FIG. 16.2). When a selection is made the Automated Analysis Services are activated. Existing structures are then applied to the new data. FIG. 16.4 and FIG. 17.4 demonstrate the difference in query results when applying previous study structures to new data. FIG. 16.3 and FIG. 17.3 demonstrate the same structure, but different results applying to the same categories.

The following describes a software application according to a preferred embodiment of the present invention:

The referenced software application is a powerful statistical intelligence-based enterprise software application that allows business users to compile deep content analysis and create complex study reports with highly analytical requirements. The application is primarily designed to enhance end-user abilities and automate the comprehensive content analysis of a mass of individual electronic consumer communications, and retain the quantitative dimensions of the data as it is categorized.

The application gives users the ability to extract data from various electronic data sources, analyze mass amounts of data by creating dynamic queries, caching relevant data locally to achieve better performance and guiding users to make the best informed study development decisions as the data is being explored.

The application is a powerful, fast, and intuitive consumer intelligence software application that was designed to benefit from the cutting edge Microsoft.NET Framework (C#) services-centric paradigm. The application utilizes several types of services: Windows Services, Analysis Services, and Web Services.

Formerly known as NT services, the MS Windows Services enable the creation of long-running executable applications that occupy their own Windows sessions. These services can be automatically started when the computer boots, can be paused and restarted, and do not expose any user interface. Windows Services are currently platform dependent and run only on Windows 2000 or Windows XP.

Web Services provide a new set of opportunities that the application leverages. A Microsoft NET Framework using uniform protocols such as XML, HTTP, and SOAP allows the utilization of the application through Web Services on any operating system. Taking advantage of Web Services provides architectural characteristics and benefits—specifically platform independence, loose coupling, self-description, and discovery—and enables a formal separation between the provider and user. Using Web Services increases the overall performance and potential of the application, leading to faster business integration and more effective and accurate information exchanges.

The application's Analysis Services represented in the client front-end delivers improved usability, accuracy, performance, and responsiveness. The application's Analysis Services are a feature rich user interaction layer with a set of bound custom designed controls—demonstrating a compact and manageable framework. The complexity of back-end processing is hidden from the end user—they see only the processed clean study data that is relevant to their exploration path and activity—enabling them to make better decisions and take faster actions.

The major functions of a software application according to a preferred embodiment of the present invention are:
Automatic Database Creation
Data Gathering
Data Transformation
Data Analysis
Study Composition
   Application Database Service: Representing a very powerful element within the architecture, as a part of the application's Central Management Service, this service enables automatic Database creation. This component is capable of creating highly complex databases in less than one minute. The Application's Entity Schema is defined in an XML document that includes information on what properties are associated with each entity, and how the entities are related. This document describes the options provided in the XML document as well as the organization of the document. The master-schema element is the root element of the XML document and is processed by the Central Management Service which parses the XML schema entity to create a new database. The Central Management Service is a Windows Service responsible for completing several key tasks. (See discussion below.)

Data Gathering Service: Currently comprised of web crawlers, this service retrieves information from pre-determined data sources such as online message boards. Each message board has its own very specific display characteristics and organization and requires close examination. Many message boards follow a tried-and-true pattern of organization: community, boards, topics, and messages. The structure of each community source is presented in an XML file, which is then processed by the Data Gathering Service and the database is populated for analysis. (See discussion below.)

Data Transformation Service: The Data Transformation Service is a critical component of the application's architecture. It ultimately delivers clean, searchable, and comprehensible data to the end-user. The contained Word Parse Service and Phrase Parse Service are performed during data cleaning, followed by custom aggregation tasks to create the Words and Phrases Catalog (WPC)—at the heart of the application. The WPC combined with the SQL Server Full-text indexes and the way they function through the user interface produces a graphic view of the core elements of the content of the data itself. (See discussion below.)

Data Analysis Service: The Data Analysis Service enables the application's unique ability to easily and intuitively perform complex text-retrieval and relational database interactions. The multi-tier client server application allows the end user to query the database using full-text catalogue queries and assign those query results to a predefined study category. At the same time, the application's Words and Phrases Catalogue presentation is modified by each query result and displays only related words and phrases. This simple drill-down display enables quick identification of granular elements within a category, and leads to the fast recognition of active trends. A Graphic Timeline custom control shows activity over time and allows drill-down to the minute. Data can also be grouped and viewed by source, board, thread, topic, and author and time range. (See discussion below.)

Study Composition Service: This service is comprised of two core components: the Study Working Environment and Study Outline Environment. This is a Web Service, generated by the activities performed within the Data Analysis Service. The Study Working Environment is a standard tree structured Study Document Object Model. There are set of default entities: Introduction, Executive Summary, Quantitative Analysis I, Quantitative Analysis II, Study Insight, etc. Query results and refined data sets are assigned to study specific categories and subcategories in the Study Working Environment leading to a tiered grouping of relevant data and study categorization. The application computes the results of the quantitative elements of the categorization process and generates charts or graphs for inclusion in the Study Outline Environment. The Study Outline Environment houses the final study and can output the study report to multiple report templates for presentation.

The software of the preferred embodiment of the present invention represents a rich and comprehensive enterprise application that may be used to provide an array of potential business solutions. It has been designed using a services-centric paradigm and an n-tiered architecture based on a Microsoft Windows.NET platform.

The application architecture uncovers new opportunities for extracting and working with large amounts of data from various worldwide data sources. The application analyzes study data by creating dynamic queries to provide quantitative analysis and to produce accurate final study reports with high analytical requirements. All back-end work and processing is managed by services and are invisible to the end user.

Services are a nascent component in the application's architecture and perform five major functions: Automatic Database Creation, Data Gathering, Data Transformation, Data Analysis, and Study Composition. Each function represents a set of tasks that are handled through one or more services.

The application is primarily designed to automate the comprehensive content analysis of messages in various formats published by different individuals sharing their opinions and beliefs across a vast array of online offerings. Business analysts determine which data source(s) are most suitable for a particular study, and the operator examines the availability and accessibility of each data source and begins to initialize the crawlers.

Preparing the crawlers to extract data from a new source can be time consuming. Every site and offering is unique, and while some use the same popular message systems and architectures, others use proprietary systems or unique authorization schemes that can create challenges. Before actual crawling takes place, each site is tested by the application's Site Analyzer Tool to uncover the nuances and specific variations to the Community, Boards, Topics, and Messages format. The structure of each source is preserved in the “Command-Set-[StudyName].xml” file, which is processed by the Web Crawler Unit and data is extracted into database for further analysis.

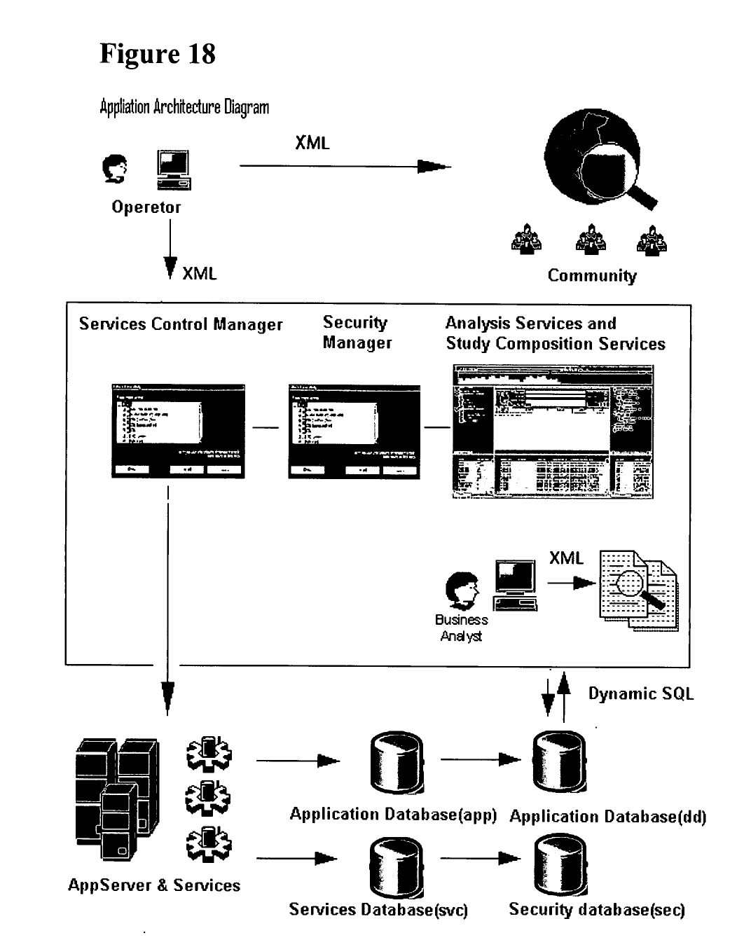

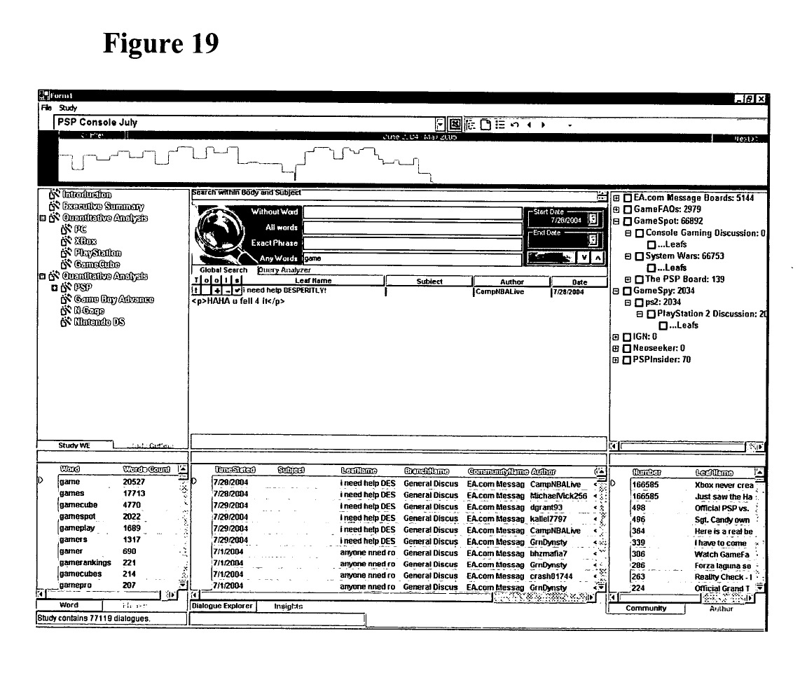

Services Control Manager (Study Data Control) represents an operator interface that interacts with the other services, displays the processes that are currently running and reports the status of the study, giving access to the “start,” “end,” and “fail” modes. If any of the services failed, the operator may start them again or examine the log file. The Services Database (SVC) retains information about all services, tasks, and their respective status. (See FIG. 18.)

Application Database Services are part of the Management Central Service and provide the application's automatic Database creation. The structure of the database is defined in the Application Entity Schema—XML document. It includes information on what properties are associated with each entity, and how the entities are related. The service parses the XML document and delivers commands to create the Application Database.

Data Gathering Services can retrieve (crawl) information from pre-determined data sources such as community message board, chats, blogs, etc. The display structure of each source is defined and stored within the “Command-Set-[StudyName.xml]” file and the “config.xml” file. A separate “Command-Set-[StudyName].xml” file is assigned to each study, while the “Config.xml” file accumulates all of the source configurations in one file. Data Transformation Services are activated during new database population. The Word Parse Service and Phrase Parse Service are active in data cleaning, words and phrases parsing, and words grouping and aggregation to create the application's Words and Phrases Catalog (WPC). The dialogue aggregation and presentation of the source hierarchy also take place through the Data Transformation Services and play a key role during analysis. The final step within the Data Transformation Services is the creation of the dimensional data cube.

The application utilizes the Multidimensional Data Analysis principles provided by Microsoft SQL Server 2000 with Analysis Services, which is also referred to as Online Analytic Processing (“OLAP”). These principles are applied to the data mining and analysis of the text that comprises the dialogue records. The use of Multidimensional Analysis and OLAP principles in the design of the application provides a number of key benefits, both for the short and long term.

The Data Analysis Services enable the application's unique ability to easily and intuitively perform complex text-retrieval and relational database interactions. The multi-tier client server application is comprised of: (i) Presentation Layer; (ii) Business Layer; and (iii) Data Layer.

The Presentation Layer is the set of custom built and standard user controls that define the compact application framework, successfully leveraging local computer resources such as .NET graphics, attached Excel, and local storage. This approach has made it possible to develop a very flexible and feature rich application that would not be possible with a web-based application. Tabbed controls throughout the interface allow for its sophisticated and highly manageable desktop design.

The Business layer handles the application's core business logic. The design allows end users to query the database using dynamic full-text catalogue queries and to assign refined and final result sets to predefined categories within the study. At the same time, the application's Words and Phrases Catalogue is associated uniquely to each query result and displays only related words and phrases, making it easier to determine the leading consumer concepts and trends within a current study.

The Data Layer of the Data Analyses Services is responsible for all data associations and interactions. The application uses the SQL Client data provider to connect to the SQL Server database. Microsoft ADO.NET objects are then used as a bridge to deliver and hold data for analysis. There are two types of data interaction: direct dynamic full-text catalogue queries, which access the database and deliver results and caches data. The cache is a local copy of the data used to store the information in a disconnected state (Data Table) to increase data interaction performance.

Regarding Application Services, the application's Data Analysis Services demonstrate its unique capacity to quickly perform complex text-retrieval and relational database interactions. The compact design allows the end user to create dynamic queries using full-text catalogue query statements. The Microsoft SQL Server 2000 full-text index provides support for sophisticated word searches in character string data and stores information about significant words and their location within a given column. This information is used to quickly complete full-text queries. These full-text catalogues and indexes are not stored in the database they reflect, making it impossible to run them within the DataSet (ADO.NET disconnected object). They therefore have to be passed directly to the database. The full-text.catalogue query utilizes a different set of operators than the simple query—more powerful and returning more accurate results.

As depicted in FIG. 19, end users select an active study from the combo box at the top left of the graphic user interface window, and can work with only one study at a time. A new study displays the Study Working Environment, Study Outline, and Query History blank.

End user search, grouping, and analysis processes often begin from exploration of the Word and Phrase panel—WPC (Word & Phrase Catalog). The WPC panel groups and contains the most prolific and significant words and phrases within the data that serves to guide end users toward the most prevalent and significant concepts and themes—without the noise—held in the multitude of dialogue records that make up the source of the study report.

By double clicking on a listed word or phrase in the WPC panel the application generates an appropriate query. The status bar displays the total amount of dialogue and query result related to the Dialogue Manager. The search criteria and query result will be saved in the Query Analyzer. Users may achieve the same effect by typing search word and phrases in the search text box and then pressing the search button. All search words are highlighted in the Dialogue Manager.

It is worth emphasizing that the Word and Phrases Catalog (WPC), displayed in the front end Word and Phrases panel, is fully dynamic and affected by every single search or combination of parameters. The ‘Word Count’ and ‘Phrase count’ will be different in each instance. This is because each dialogue is composed of regular words and phrases, and the application knows which word and phrase belong to which dialogue unit. By running different queries the application will produce different results and the associated amount of words and phrase will be affected.

There is another very attractive component of the system, which is the Timeline custom-made user control (at the top of the active application window). The Timeline control is designed to use GDI+ to render graphical representations of dialogue activity over time, and allows users to drill down data sets to the minute.

Business analysts may select from a variety of search criteria to compose these dynamic queries: All words, Any Words, All phrases and Without Words, Community Source, Author, Date/Time Range.

The dynamic query is then sent to the data source for data retrieval. While the amount of queries is unlimited, only one query result can be assigned to a study category or subcategory. There are multiple options incorporated into the application's search interface: the down arrow combines any query from the Query Analyzer with a current query, using the ‘OR’ clause, can produce drill down searches and the up arrow—the “AND” clause, can produce expanded search results.

Study Composition Services: The Study Composition Service is a generic component of the Study Analysis Services. The Study Composition Service contains two core components: (i) Study Working Environment; and (ii) Study Outline.

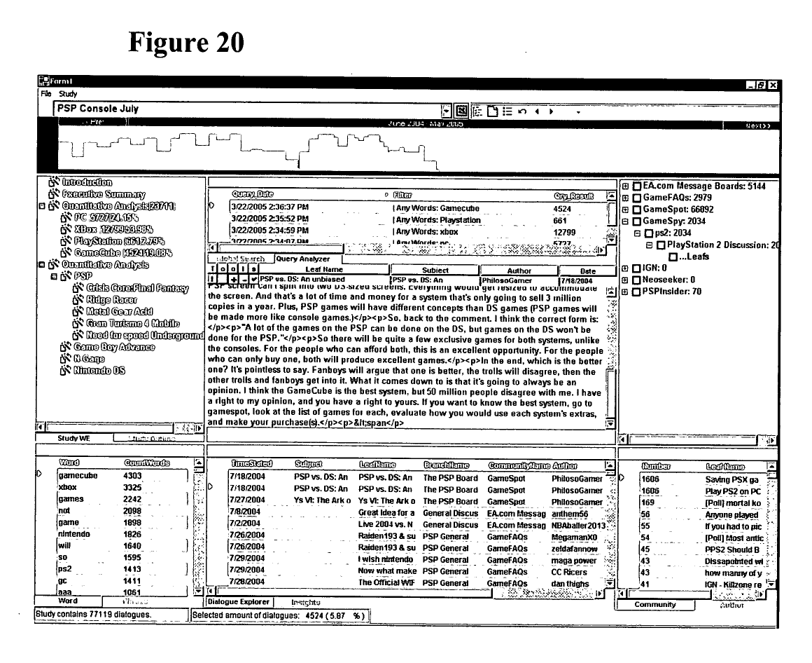

As shown in FIG. 20, the Study Working Environment (Study WE) is a standard tree structured Object Model with a set of default entities including an Introduction section, an Executive Summary, and one or more Quantitative Analyses.

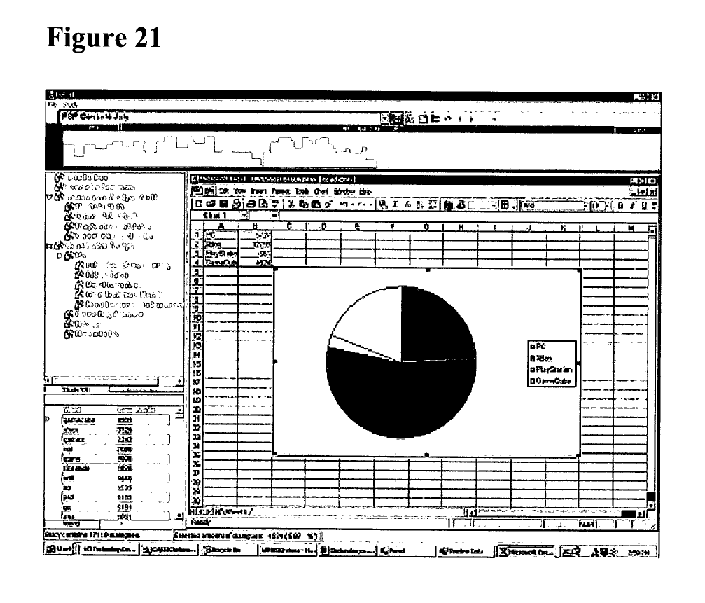

When the query result is finalized, a business analyst can assign the result and its associated data records to a particular category—data categorization. The quantified elements of a final query result and its hosting category are computed by the application, which then generates appropriate charts or graphs (see, e.g., FIG. 21). The charts or graphs are generated through the seamless incorporation of Microsoft®'s Excel, providing a familiar interface and easy customization. Analysts' insights and notes are another type of entity, which can be assigned to any part of the study's working environment. The study working environment is just that, a free and configurable space for collecting and quantifying findings, keeping notes, and developing the elements that will constitute the final study in the study outline environment.

Often, and in projects that require recurring delivery of a study, the business analysts will create a new study based upon an existing one, or an existing outline template. The application's Web Service allows for this by expanding in XML format all of the data and structure of each existing study, creating a reference for the application's Data Analysis Service. Business analysts can then create new queries against existing categories and produce new studies with updated results with less effort.

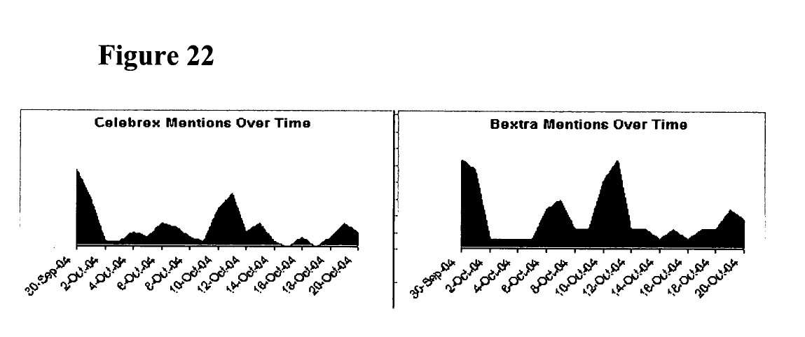

Time Line custom control generates a graph to show brand mentions over time. (See, e.g., FIG. 22.)

Regarding Automatic Database Creation, the application's Database Service (a component of the Management Central Service) provides automatic Database creation, which represents a unique element in the application architecture. It is capable of creating highly complex database in less then sixty seconds.

The application's Entity Schema is also defined within an XML document, and includes information on what properties are associated with each entity, and how the entities are related. This document further describes the options provided in the XML document and the organization of that document. The master-schema element is the root element of the XML document.

The schema element is used to group related entities, and is divided into three specific schemas: Dialogue; Application; and Security. The Dialogue Database contains all of the data that will be analyzed. The Application Database contains all of the Study structure information. The Security Database maintains users, groups, and permissions. (See FIG. 18.)

The schema element has three attributes: name, prefix, and type. The prefix will be appended to all table names in that schema to distinguish them from other schema's tables. The type attribute is informational only, and can be used to distinguish between OLTP and OLAP tables.

The entity element describes the specific entities in a given schema. Entities are discrete containers of information, but do not directly correspond to database tables. Entities can be made up of many different tables. The entity element has five attributes: name, maintain-history, can-be-cloned, is-lockable, and archive. The maintain-history attribute is a Boolean that indicates if the system should maintain a revision history for the entity. The revision history permits seeing earlier versions of the data, and who and how it was changed. It also permits rolling back to earlier revisions and processes.

From a database perspective, the revision history works as follows:

—T_ENTITY—

ENTITY_ID

NAME

DESCRIPTION

CREATE_DATE

LAST_MODIFIED

DELETED

The property element is used to describe the specific data that can be associated with an Entity. This corresponds to non-foreign key fields in the master table for an entity. The property element has eight attributes: name, type, length, required, is-searchable, unique, value-list, and default.

The related-entity element is used to describe relationships between entities. This element has eight attributes: type, enforced, unique-group schema, entity, predicate, asynchronous-edit, asynchronous-edit-history, and asynchronous-edit-lockable. The type attribute indicates what type of relationship should be created between entities. The first type is “doublet,” which means that the given entity can be related to only one other entity for that relationship. This describes a one-to-many relationship. The other type of relationship is a “triplet,” which means that the given entity can be related to many other entities for that relationship. This describes a many-to-many relationship. The presence of a triplet creates an additional table to relate the two entities together.

The Management Central Service parses the application-schema.xml document and related XML transformation files:01-create-databases.xslt, 02-create-tables.xslt, 03-foreign-keys-indexes.xsl, 04-full-text-catalog.xslt in order to create and populate the appropriate database.

The application's Management Central Service monitors all of the other active services to determine when the next step in any given process can proceed, allowing the application's Services Control Manager (SDC) to stop running when it is no longer needed. The SDC can also communicate through the Management Central Service to provide detailed progress reports on individual studies.

Regarding Data Gathering, the application's Dialogue Gathering Service is a flexible and customizable content crawler designed for collecting data from blogs, message boards, emails, newsgroups, chats and other “CGM” (Consumer Generated Media) outlets. It receives instructions from the application's Service Manager and begins a threaded set of processes to gather CGM from the specified sources.

Many standard sources follow a tried-and-true pattern of organization:
Top level (which we refer to as the “root”) that has links to boards. Each of these links is a branch (see below).
Board level (called a branch). Some offerings comprise multiple branch levels, and The application's XML schema accommodates such configurations. Clicking a board link will advance to the thread level (see below)
Thread level (called a leaf or topic) contains a list of the threads within the current board level offering. Each thread is a discussion, with a very specific and identified topic. The thread level may be paginated, as there are likely many discussions within a single board level. Some threads only contain a single message, and perhaps a response or two; other, more popular threads may contain thousands of messages.
Message level (called the dialogue unit level) contains the contents and particulars of the messages themselves. Most popular offerings, at the board level, contain ten to twenty-five messages per page.

The source configuration for the Data Gathering Service requires knowledge of Regular Expressions, which are used to parse the desired content from the HTML source of each page.

When each web page is requested, the returned source is converted to XHTML using Tidy. This cleans up the source in a standard format and makes it easier to write functional Regular Expressions.

The config.xml file is the primary configuration file for the crawlers. It contains the hierarchy definitions for each source, from which the actual hierarchy files can be derived. And from those hierarchy files, the crawler command-set files are created.

The config.xml file contains the following nodes:

```
<data-source>
  [server, database, username, password] - The connection details for the
  application database
<data-destination>
  [path] - The network path where the command-set files are saved
<communities>
  <community>
    [name] - The name of the community
    <authentication> (optional)
      [action] - The login URL, derived from the action attribute of
      the login form.
      [method] - The HTTP method, derived from the method
      attribute of the login form.
      <headers> - The HTTP headers, as sent when the login form is
      being processed.
        There is a plug-in for Internet Explorer that can capture
        the page headers, as they are sent/received. The utility
        is called HTTPHeaders and is on the network at
        \\bbifile\Development\Projects\Application\ieHTTPHeaders
        There is also a plug-in for the Mozilla/Firefox browser
        that does the same thing. It is a bit more robust. It can
        be downloaded from http://livehttpheaders.mozdev.org/
        <parameter> - The name/value pairs being sent to the
        host.
      <content> - The content of each element of the login form. As
      JavaScript can sometimes modify this data, it is easiest to
      extract this content from the captured HTTP headers as well.
        <parameter> - The name/value pairs being sent to the
        host.
    <region> - Globalization details, to account for time differences on
    web sites that are based outside of the US.
      [culture-code] - Typically set to “en-US”. A complete list of
      ISO country and language codes is available from Microsoft.
    <root-config> - Defines the “root”, or starting point of the crawler,
    for the site in question.
      [name] - The name of the site/message board.
      [url] - The URL from which to start crawling; the “root” page.
      [site-def-doc] - The network path of the hierarchy document
      for this web site.
      <branch-config> - The configuration of a branch-level of the
      message board. There can be multiple branch-config nodes,
      and they can be nested infinitely to reflect many variations of
      message board hierarchy.
        [hierarchy-level] - Set to “B” for the branch level node.
        [regex] - A regular expression that uses referenced
        grouping to extract specific information from the
        XHTML source.
        [name-id] - The grouping number of the name/title.
        [url-id] - The grouping number of the URL.
        [lastpost-id] - The grouping number of the timestamp.
        If the timestamp is not available, set this value to −1.
      The branch-config level can continue indefinitely. There must
      be at least one branch-config node, but there may be as many as
      necessary to represent the message board.
        <leaf-config> - The configuration of the leaf-level of
        the message board. This consists of a list of
        threads/discussions.
        [regex] - A regular expression that uses referenced
        grouping to extract specific information from the
        XHTML source.
        [name-id] - The grouping number of the name/title.
        [url-id] - The grouping number of the URL.
        [lastpost-id] - The grouping number of the timestamp.
        If the timestamp is not available, set this value to −1.
        [paging-regex] - A regular expression used to extract
        the URL of the next page (if applicable). This regular
        expression uses referenced grouping.
        [paging-url-id] - The grouping number of the paging
        URL. If there is no paging, set to −1.
        <dlu-config> - The configuration of the dialogue unit
        level.
          [regex] - A regular expression that uses
          referenced grouping to extract specific
          information from the XHTML source.
          [author-id] - The grouping number of the
          author. Set to −1 if there is no author field.
          [subject-id] - The grouping number of the
          subject. Set to −1 if there is no author field.
          [body-id] - The grouping number of the
          message body.
          [datetime-id] - The grouping number of the
          timestamp. Set to −1 if there is no author field.
          [paging-regex] - A regular expression used to
          extract the URL of the next page (if applicable).
          This regular expression uses referenced
          grouping.
          [paging-url-id] - The grouping number of the
          paging URL. If there is no paging, set to −1.
          [pattern-reply-to] - A regular expression that
          uses referenced grouping to extract any quoted
          text from the message body. The grouping id is
          set to 1. If there are no quoted texts, then leave
          this attribute empty.
          [pattern-signature] - A regular expression that
          uses referenced grouping to extract any
          signature text from the message body. The
          grouping id is set to 1. If there are no signatures,
          then leave this attribute empty.
```

Regarding Data Cleaning Process, the Dialogue Gathering Service handles the data cleaning functionality as it crawls, organizing and cleaning up the message portion of each dialogue unit before they are populated into the database.

Each message may contain the flowing sections: reply-to text, content text (the “body” of the message), and signature text. It is expected that every message will contain at least one of these—if not, then that message is empty (or will be considered so, after excess HTML/garbage content is removed) and will not be inserted. A blank message is useless to the system and only causes clutter and possible confusion. Each message may contain only a single signature section, but multiple content and reply-to sections may exist.

When the unprocessed message data enters the data cleaning stage, it consists of the XHTML (previously converted from the HTML source) and content that was recognized by a specific Regular Expression as being a message, such as the following example:

```
<blockquote>
    quote:
    <hr />
    <i>Originally posted by Arkzein</i> <br />
    <b>Would be extremely hard to do (ie just looking at writing
    them down) unless you let poeople pick usergroups I believe.</b>
    <hr />
</blockquote>
<br />Stop using sophistimacated words<br />
I don't get it at all.<br />
<p>
<br />Question: What do you do if you don't like chicken? <br />
<br />Answer: You don't eat chicken!
<br />----------<br />
<br />Question: What do you do if you don't like beef
<br />Answer: You eat chicken!<p> <br /> <br />
<p class=“c3”>
```

This text is compared against the Regular Expressions that define the structure of signature text, reply-to text, and content text within the current site structure. An XML document is then constructed, using <div> tags for each node; where each <div> tag has a class attribute, the value of which defines the contents—signature, reply-to, or content.

The text content of each XML node is also cleaned and reformatted. Block-style HTML containers are replaced with <p> tags, and excess HTML is removed. At this time, images and links are removed—this is subject to change through pre-defined filter activities.

The <div> and <p> tags are used (as opposed to proprietary tags) so that, when necessary, this content can be displayed as HTML without the need to reformat the text. This XML document is converted to a string, which is inserted into the OriginalMessage column of the ddDialogueUnit table (Application Database (dd), see above). So the ultimate result is an XML document structure such as the following:

```
<div class=“dialogue-unit”>
  <div class=“reply-to”>
    <p>Originally posted by Arkzein</p>
    <p>Would be extremely hard to do (ie just looking at writing
    them down) unless you let poeople pick usergroups I believe.</p>
  </div>
  <div class=“content”>
    <p>Stop using sophistimacated words</p>
    <p>I don't get it at all.</p>
  </div>
  <div class=“signature”>
    <p>Question: What do you do if you don't like chicken?</p>
    <p>Answer: You don't eat chicken!</p>
    <p>----------</p>
    <p>Question: What do you do if you don't like beef</p>
    <p>Answer: You eat chicken!</p>
  </div>
</div>
```

The CleanedMessage column of the ddDialogueUnit table does not need to contain reply-to and signature text, nor are the XML tags necessary. A string is constructed from all “content” nodes in the above XML document, retaining the paragraph structure, and this is inserted into the CleanedMessage column, as seen then in this example:

<p>Stop using sophistimacated words</p>
<p>I don't get it at all.</p>

Data Transformation Services: Data Transformation Services are a critical and unique component of the application architecture. These services deliver clean, searchable, comprehensible data through the following two individual services:
Word Parsing Service (WoPS)
Phrase Parsing Service (PHPS)

The Word Parsing Service (WoPS) starts along with the Dialogue Gathering Service and parses the individual words from each individual message. The resulting index is sent to the BuLS (text file) where the application's Management Central service provides spell check analysis, word grouping and aggregation.

The Phrase Parsing Service (PhPS) initiates upon the completion of the Word Parsing Service (WoPS), and uses the word data to reconstruct repeat phrases. These are used for analysis as well as signature and reply detection. These resulting indexes are sent to the BuLS (text file) where the application's Management Central service provides phrases grouping and aggregation.

What is claimed is:

1. A method for analyzing message data collected from one or more online sources, comprising the steps of:
transforming the collected message data into graphically searchable data comprising a plurality of message data units, each of which includes at least a dialogue portion, and a words catalog;
displaying at least a portion of the graphically searchable data;
querying the graphically searchable data; and
displaying at least a portion of the results of the query.

2. The method according to claim 1, wherein the transforming step further includes generating a phrases catalog.

3. The method according to claim 1, wherein the querying step includes entering one or more search terms and identifying each message data unit within the graphically searchable data that includes at least one of the search terms within the dialogue portion of the message data unit.

4. The method according to claim 3, wherein the step of displaying at least a portion of the results of the query includes making available for display all words in the words catalog that are included in the identified message data units.

5. The method according to claim 2, wherein the step of querying includes entering one or more search terms and identifying each message data unit within the graphically searchable data that includes at least one of the search terms within the dialogue portion of the message data unit.

6. The method according to claim 5, wherein the step of displaying at least a portion of the results of the query includes making available for display all phrases in the phrases catalog that are included in the identified message data units.

7. The method according to claim 1, wherein the step of transforming includes creating a plurality of data dimensions.

8. The method according to claim 7, wherein the data dimensions include at least author and message date.

9. The method according to claim 8, wherein the querying includes selecting one of the data dimensions.

10. The method according to claim 1, further comprising the step of:
incorporating the query results into a study.

11. A computer device including a processor, a memory coupled to the processor, and a program stored in the memory, wherein the computer is configured to execute the program to perform the steps of:
transforming message data collected from one or more online sources into graphically searchable data comprising a plurality of message data units, each of which includes at least a dialogue portion, and a words catalog;
displaying at least a portion of the graphically searchable data;
querying the graphically searchable data; and
displaying at least a portion of the results of the query.

12. The computer device according to claim 11, wherein the step of transforming further includes generating a phrases catalog.

13. The computer device according to claim 11, wherein the step of querying includes entering one or more search terms and identifying each message data unit within the graphically searchable data that includes at least one of the search terms within the dialogue portion of the message data unit.

14. The computer device according to claim 13, wherein the step of displaying at least a portion of the results of the query includes making available for display all words in the words catalog that are included in the identified message data units.

15. The computer device according to claim 12, wherein the step of querying includes entering one or more search terms and identifying each message data unit within the graphically searchable data that includes at least one of the search terms within the dialogue portion of the message data unit.

16. The computer device according to claim 15, wherein the step of displaying at least a portion of the results of the query includes making available for display all phrases in the phrases catalog that are included in the identified message data units.

17. The computer device according to claim 11, wherein the step of transforming includes creating a plurality of data dimensions.

18. The computer device according to claim 17, wherein the data dimensions include at least author and message date.

19. The computer device according to claim 18, wherein the step of querying includes selecting one of the data dimensions.

20. The computer device according to claim 11, further comprising the step of:
incorporating the query results into a study.

21. A computer readable storage medium having stored thereon a program executable by a computer processor to perform the steps of:
transforming message data collected from one or more online sources into graphically searchable data comprising a plurality of message data units, each of which includes at least a dialogue portion, and a words catalog;
displaying at least a portion of the graphically searchable data;
querying the graphically searchable data; and
displaying at least a portion of the results of the query.

22. The computer readable storage medium according to claim 21, wherein the step of transforming further includes generating a phrases catalog.

23. The computer readable storage according to claim 21, wherein the step of querying includes entering one or more search terms and identifying each message data unit within the graphically searchable data that includes at least one of the search terms within the dialogue portion of the message data unit.

24. The computer readable storage medium according to claim 23, wherein the step of displaying at least a portion of the results of the query includes making available for display all words in the words catalog that are included in the identified message data units.

25. The computer readable storage medium according to claim 22, wherein the step of querying includes entering one or more search terms and identifying each message data unit within the graphically searchable data that includes at least one of the search terms within the dialogue portion of the message data unit.

26. The computer readable storage medium according to claim 25, wherein the step of displaying at least a portion of the results of the query includes making available for display all phrases in the phrases catalog that are included in the identified message data units.

27. The computer readable storage medium according to claim 21, wherein the step of transforming includes creating a plurality of data dimensions.

28. The computer readable storage medium according to claim 27, wherein the data dimensions include at least author and message date.

29. The computer readable storage medium according to claim 28, wherein the step of querying includes selecting one of the data dimensions.

30. The computer readable storage medium according to claim 21, further comprising the step of:
incorporating the query results into a study.

31. A message data analysis system comprising:
message data;
means for transforming the message data into graphically searchable data comprising a plurality of message data units and a words catalog;
means for displaying at least a portion of the graphically searchable data;
means for querying the graphically searchable data; and
means for displaying at least a portion of the results of the query.
